(19) United States
(12) Patent Application Publication
(10) Pub. No.: US 2008/0289307 A1
(43) Pub. Date: Nov. 27, 2008

(54) HONEYCOMB STRUCTURE, METHOD FOR MANUFACTURING HONEYCOMB STRUCTURE, AND EXHAUST GAS PURIFYING APPARATUS

(75) Inventors: Kazutake OGYU, Ibi-gun (JP); Yusuke Kondo, Ibi-gun (JP)

Correspondence Address: DITTHAVONG MORI & STEINER, P.C., 918 Prince St., Alexandria, VA, 22314, US

(73) Assignee: IBIDEN CO., LTD., Ogaki-shi (JP)

(21) Appl. No.: 12/123,955

(22) Filed: May 20, 2008

(30) Foreign Application Priority Data
May 25, 2007 (JP) PCT/JP2007/060734

(51) Int. Cl. B01D 39/20; B32B 3/12; B01J 23/00; B01J 35/00; C04B 35/00

(52) U.S. Cl. 55/523; 428/116; 502/300; 502/304; 264/630

(57) ABSTRACT

A honeycomb structure includes a plurality of cells, an inorganic fiber, and an inorganic matter. The plurality of cells are disposed substantially in parallel with one another in a longitudinal direction with a cell wall therebetween. The inorganic matter forms a fixed portion in which said inorganic fibers are fixed to one another, part of the fixed portion having a fissure.

### CROSS-REFERENCE TO RELATED APPLICATIONS

The present application claims priority under 35 U.S.C. §119 to PCT Application No. PCT/JP2007/060734, filed on May 25, 2007, the contents of which are incorporated herein by reference in their entirety.

### BACKGROUND OF THE INVENTION

1. Field of the Invention

The present invention relates to a honeycomb structure, a method for manufacturing a honeycomb structure, and an exhaust gas purifying apparatus.

2. Discussion of the Background

Recently, particulates (hereinafter, also referred to as PMs), which are contained in exhaust gases discharged from internal combustion engines of vehicles, such as buses and trucks, and construction machines and the like, have raised serious problems as those particulates are harmful to the environment and the human body. Various kinds of filters have been proposed as filters for capturing PMs contained in exhaust gases and thereby purifying the exhaust gases by passing the exhaust gases through a porous material.

As the filters for capturing PMs contained in exhaust gases and thereby purifying exhaust gases, for example, there have been proposed various kinds of filters with use of a lamination-type honeycomb structure manufactured by laminating lamination members having through holes (for example, WO 2006/092986 A1).

This honeycomb structure is a laminated body formed by laminating sheet-shaped lamination members each including inorganic fibers and an inorganic matter. The lamination members are laminated in such a manner that through holes are superimposed on one another in the longitudinal direction, and cells are formed by the superimposed through holes. In addition, lamination members for an end portion are laminated in the end portions so that through holes are sealed in a checkered pattern. Thereby, PMs in exhaust gases are captured by a cell wall separating each of the cells when the exhaust gases containing PMs pass from one cell to another cell, leading to purification of the exhaust gases.

The contents of WO2006/092986 A1 are incorporated herein by reference in their entirety.

### SUMMARY OF THE INVENTION

A honeycomb structure according to the present invention includes a plurality of cells, an inorganic fiber, and an inorganic matter. The plurality of cells are disposed substantially in parallel with one another in a longitudinal direction with a cell wall therebetween. The inorganic matter forms a fixed portion in which the inorganic fibers are fixed to one another, part of the fixed portion having a fissure.

A method for manufacturing a honeycomb structure including a honeycomb member according to the present invention includes preparing a mixture containing an inorganic fiber and a raw material of an inorganic matter having a melting point lower than a melting point of the inorganic fiber. The mixture is molded to manufacture a honeycomb molded body in which a plurality of cells are disposed substantially in parallel with one another in a longitudinal direction with a cell wall therebetween. The honeycomb molded body is heated at a temperature lower than the melting point of the inorganic fiber and not lower than the melting point of the raw material of the inorganic matter. The heated honeycomb molded body is cooled to manufacture the honeycomb member and to introduce a fissure into a fixed portion in the honeycomb member by setting an average changing rate of temperature dropping to a normal temperature at at least about 50° C./hr and at most about 500° C./hr, the fixed portion being formed by fixing the inorganic fibers to one another by interposing the inorganic matter in the honeycomb member.

An exhaust gas purifying apparatus according to the present invention includes a honeycomb structure, a member for an end portion, and a casing. A first member for the end portion is disposed on a side of a first pressing metal member in the casing. The honeycomb structure is disposed in the casing, through holes of the honeycomb structure being aligned with through holes of the first member for the end portion. A second member for the end portion is disposed on a side opposite to a side of the first member for the end portion, through holes of the second member for the end portion being aligned with the through holes of the honeycomb structure. A second pressing metal is disposed on the second member for the end portion. The honeycomb structure has a pillar shape in which a plurality of cells disposed substantially in parallel with one another in a longitudinal direction with a cell wall therebetween and includes an inorganic fiber, and an inorganic matter. The inorganic matter forms a fixed portion in which the inorganic fibers are fixed to one another, part of the fixed portion having a fissure.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1A is a perspective view that schematically illustrates one example of a honeycomb structure according to the first embodiment of the present invention, and FIG. 1B is a cross-sectional view taken along line A-A of FIG. 1A.

FIG. 2 is a perspective view that schematically illustrates one example of an embodiment of a fixed portion in which an inorganic matter firmly fixes inorganic fibers to one another.

FIG. 3A is a perspective view that schematically illustrates a honeycomb structure according to one embodiment of the present invention and a member for an end portion that configure a honeycomb structure, and FIG. 3B is a perspective view for describing a method for disposing the member for an end portion on both end portions of the honeycomb structure illustrated in FIG. 3A.

FIG. 4 is an electron microscope photograph of a fixed portion with a fissure formed therein.

FIG. 5 is an explanatory view of a regenerating treatment apparatus.

FIG. 6 is a cross-sectional view that schematically illustrates a plunger-type molding machine.

FIG. 7A is a schematic view for describing part of processes for a method for manufacturing a honeycomb structure according to one embodiment of the present invention used for a frame member, and FIG. 7B is a top view that schematically illustrates the inside of the frame member in which pillar members are vertically installed.

FIG. 8A is a view that schematically illustrates a vessel used in a manufacturing method through the three-dimensional sheet-forming process, and FIG. 8B is a top view that schematically illustrates a vessel used in the manufacturing method through the three-dimensional sheet-forming process.

### DESCRIPTION OF THE EMBODIMENTS

The embodiments will now be described with reference to the accompanying drawings, wherein like reference numerals designate corresponding or identical elements throughout the various drawings.

In order to accomplish the object, the honeycomb structure according to the embodiments of the present invention refers to a honeycomb structure having a pillar shape in which a plurality of cells disposed in parallel with one another in a longitudinal direction with a cell wall therebetween, including: an inorganic fiber; and an inorganic matter, the inorganic matter forming a fixed portion in which the inorganic fibers are firmly fixed to one another, part of the fixed portion having a fissure.

In accordance with the honeycomb structure according to the embodiments of the present invention, since part of the fixed portion formed by the inorganic matter has a fissure, when a thermal stress arises in the honeycomb structure in use, the thermal stress may be alleviated more easily by the fixed portion with a fissure, facilitating prevention of cracking and crazing from spreading through the entire honeycomb structure. Here, without any fissure in the fixed portion, cracking and crazing may spread at a time in the entire honeycomb structure due to its low toughness. The presence of a fissure in part of the fixed portion causes alleviation of the thermal stress in the respective portions of the honeycomb structure, with the result that it may be easier to obtain a honeycomb structure having high thermal shock resistance and achieving a good balance between rigidity and toughness on the whole.

In accordance with the honeycomb structure according to the embodiments of the present invention, since the inorganic matter contains silica, it may be easier to obtain a honeycomb structure excellent in heat resistance.

In accordance with the honeycomb structure according to the embodiments of the present invention, since the inorganic fiber is at least one selected from the group consisting of a silicon carbide fiber, an alumina fiber, a basalt fiber, a silica fiber, a silica-alumina fiber, a titania fiber, and a zirconia fiber, it may be easier to improve the heat resistance of the honeycomb structure.

In accordance with the honeycomb structure according to the embodiments of the present invention, since the honeycomb structure includes one member, it may be easier to manufacture a honeycomb structure at one time without manufacturing and laminating a great number of lamination members, and consequently to improve the production efficiency of the honeycomb structure.

In accordance with the honeycomb structure according to the embodiments of the present invention, since the honeycomb structure includes a plurality of lamination members, each having high thermal shock resistance and achieving a good balance between rigidity and toughness, it may be easier to suppress possible occurrence of cracks in each of the members, consequently to enhance reliability of the honeycomb structure as a product.

In accordance with a method for manufacturing a honeycomb structure according to the embodiments of the present invention, a method for manufacturing a honeycomb structure includes: preparing a mixture containing an inorganic fiber and a raw material of an inorganic matter having a melting point less than a melting point of the inorganic fiber; molding the mixture to manufacture a pillar-shaped honeycomb molded body in which a plurality of cells are disposed in parallel with one another in a longitudinal direction with a cell wall therebetween; heating the honeycomb molded body at a temperature less than the melting point of the inorganic fiber and not less than the melting point of the raw material of the inorganic matter; cooling the heated honeycomb molded body to manufacture a honeycomb structure including a honeycomb member, wherein a fissure is introduced into a fixed portion in the honeycomb member by setting to 50 to 500° C./hr an average rate of change of the temperature drop to a normal temperature, the fixed portion being formed by firmly fixing the inorganic fibers to one another by interposing the inorganic matter in the honeycomb member.

In accordance with the method for manufacturing the honeycomb structure according to the embodiments of the present invention, a fissure maybe more easily introduced into a fixed portion by generating an appropriate thermal stress in the process of forming a fixed portion.

In accordance with the method for manufacturing the honeycomb structure according to the embodiments of the present invention, since the inorganic matter contains silica, it may be easier to manufacture a honeycomb structure excellent in heat resistance.

In accordance with the method for manufacturing the honeycomb structure according to the embodiments of the present invention, since the inorganic fiber is at least one selected from the group consisting of a silicon carbide fiber, an alumina fiber, a basalt fiber, a silica fiber, a silica-alumina fiber, a titania fiber, and a zirconia fiber, it may be easier to manufacture a honeycomb structure excellent in heat resistance.

In accordance with the method for manufacturing the honeycomb structure, since it may be easier to continuously manufacture a honeycomb molded body having a predetermined shape upon integrally molding the mixture through extrusion molding, it may be easier to further improve the production efficiency of the honeycomb structure.

In accordance with the method for manufacturing the honeycomb structure, a plunger-type molding may be employed as extrusion molding.

Since the method for manufacturing the honeycomb structure further includes the process of laminating honeycomb members having excellent thermal shock resistance and achieving a good balance between rigidity and toughness, it may be easier to enhance reliability of the honeycomb structure as a product.

An exhaust gas purifying apparatus according to an embodiment of the present invention includes a honeycomb structure, a member for an end portion, and a casing,

wherein

a first member for an end portion is disposed on a side of a first pressing metal member in the casing,

the honeycomb structure is disposed in the casing while through holes of the honeycomb structure are positioned with through holes of the first member for an end portion,

a second member for an end portion is disposed on a side opposite to a side of the first member for an end portion while through holes of the second member for an end portion are positioned with the through holes of the honeycomb structure, and

a second pressing metal is disposed on the second member for an end portion,

wherein

the honeycomb structure having a pillar shape in which a plurality of cells disposed in parallel with one another in a longitudinal direction with a cell wall therebetween, includes: an inorganic fiber; and an inorganic matter, the inorganic matter forming a fixed portion in which the inorganic fibers are firmly fixed to one another, part of the fixed portion having a fissure.

In accordance with the exhaust gas purifying apparatus according to the embodiments of the present invention, since part of the fixed portion formed by the inorganic matter of the honeycomb structure configuring the exhaust gas purifying apparatus has a fissure, when a thermal stress arises in the honeycomb structure in use, the thermal stress may be alleviated more easily by the fixed portion with a fissure, facilitating prevention of cracking and crazing from spreading through the entire honeycomb structure. Here, without any fissure in the fixed portion, cracking and crazing may spread at a time in the entire honeycomb structure due to its low toughness. The presence of a fissure in part of the fixed portion causes alleviation of the thermal stress in the respective portions of the honeycomb structure, with the result that it may be easier to obtain an exhaust gas purifying apparatus having a honeycomb structure having high thermal shock resistance and achieving a good balance between rigidity and toughness on the whole.

Although inorganic fibers firmly fixed by interposing an inorganic matter cause increase in rigidity and the resultant increase in mechanical properties such as tensile strength in the honeycomb structure described in WO 2006/092986 A1, but on the contrary, the toughness of the honeycomb structure, which is said to alleviate a thermal stress, is not as high as expected. Consequently, there remains room for improvement in the properties as the entire honeycomb structure in use.

According to the embodiments of the present invention, it may be easier to obtain a honeycomb structure improved in thermal shock resistance by achieving a good balance between rigidity and toughness.

Hereinafter, embodiments of the present invention will be described in reference to the drawings.

### First Embodiment

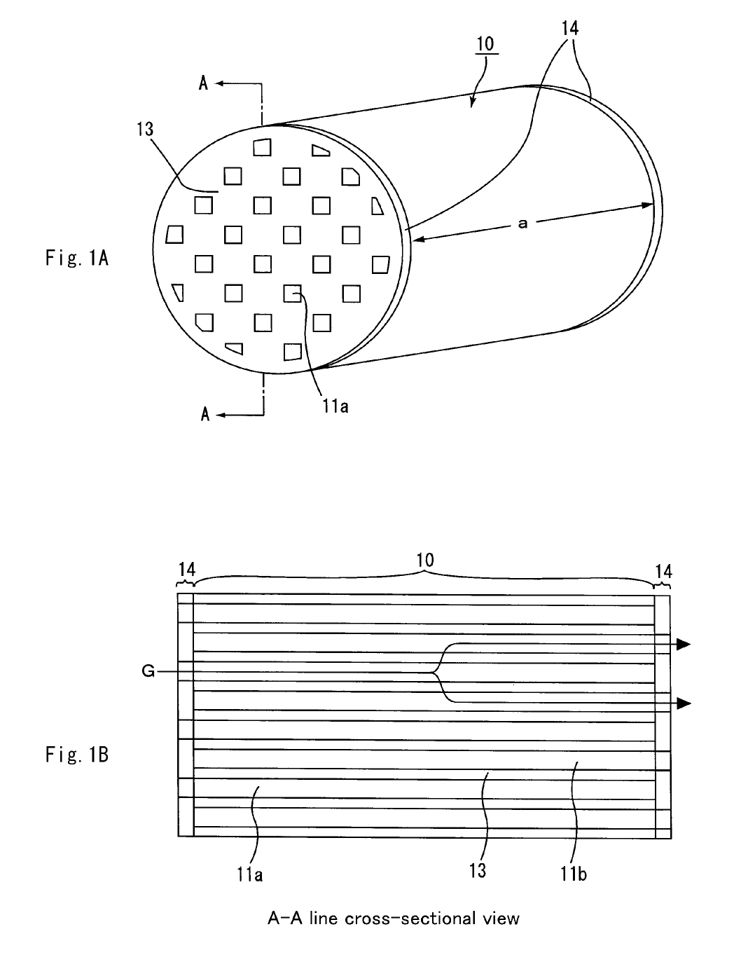

FIG. 1A is a perspective view that schematically illustrates one example of a honeycomb structure according to the first embodiment of the present invention, and FIG. 1B is a cross-sectional view taken along line A-A of FIG. 1A.

A honeycomb structure 10 according to the first embodiment mainly includes inorganic fibers and an inorganic matter, and has an integrally molded round pillar shape as illustrated in FIGS. 1A and 1B. In the honeycomb structure 10, a plurality of cells 11a, 11b are disposed in parallel with one another in a longitudinal direction (a direction shown by an arrow a in FIG. 1A) with a cell wall 13 therebetween. And as illustrated in FIGS. 1A and 1B, a metal member for an end portion 14 is disposed on both end faces of the honeycomb structure 10 so as to seal either one of the end portions of each of the cells 11a, 11b.

By disposing the member for an end portion 14 on both end faces of the honeycomb structure 10, exhaust gases G introduced from one end face of the honeycomb structure 10 (left side in FIG. 1B) into a cell 11a are allowed to flow out from a cell 11b in which the other end face (right side in FIG. 1B) is open, after always passing through a cell wall 13 separating the cell 11a and the cell 11b.

Thus, in the honeycomb structure 10, PMs in the exhaust gases G will be captured on the cell wall 13. That is, the honeycomb structure 10 on which the member for an end portion 14 is disposed functions as a filter. Here, in the case where the member for an end potion 14 is not disposed thereon, it is possible to use the honeycomb structure 10 as a catalyst supporting carrier.

The honeycomb structure 10 mainly includes inorganic fibers and an inorganic matter, and the cell wall 13 thereof has a high porosity of at least about 75% and at most about 95%.

The cell wall 13 of the honeycomb structure 10 having a porosity of about 75% or more tends not to make it difficult to perform deep-layer filtering of PMs, and also tends to make it easier to increase the inner temperature of the honeycomb structure to a temperature necessary for combustion of the PMs upon carrying out a regenerating treatment on the honeycomb structure, less likely to cause reduction in the continuous regenerating capability of the honeycomb structure.

In contrast, the cell wall 13 of the honeycomb structure 10 having a porosity of about 95% or less tends not to make the percentage of pores in the honeycomb structure too high, making it easier to properly maintain the strength of the honeycomb structure.

And the average pore diameter of the cell wall 13 of the honeycomb structure 10 is desirably at least about 10 μm and at most about 60 μm due to its suitability for performing deep-layer filtering of PMs.

The configuration of the honeycomb member 10 will be described in further detail.

The honeycomb structure 10 mainly includes inorganic fibers and an inorganic matter, and silica as an inorganic matter forms a fixed portion at which alumina fibers as inorganic fibers are firmly fixed to one another.

Here, the state in which an inorganic matter forms a fixed portion in which inorganic fibers are firmly fixed to one another refers to: a state in which the inorganic matter, which is locally located (present) at the intersection of the inorganic fibers (with or without mutual contacts among the inorganic fibers, firmly fixes the inorganic fibers to one another; a state in which the inorganic matter, which is locally located (present) in the vicinity of the intersection of the inorganic fibers, firmly fixes the inorganic fibers to one another; or a state in which the inorganic matter, which is locally located (present) over the entire area including the intersection of the inorganic fibers and the vicinity thereof, firmly fixes the inorganic fibers to one another.

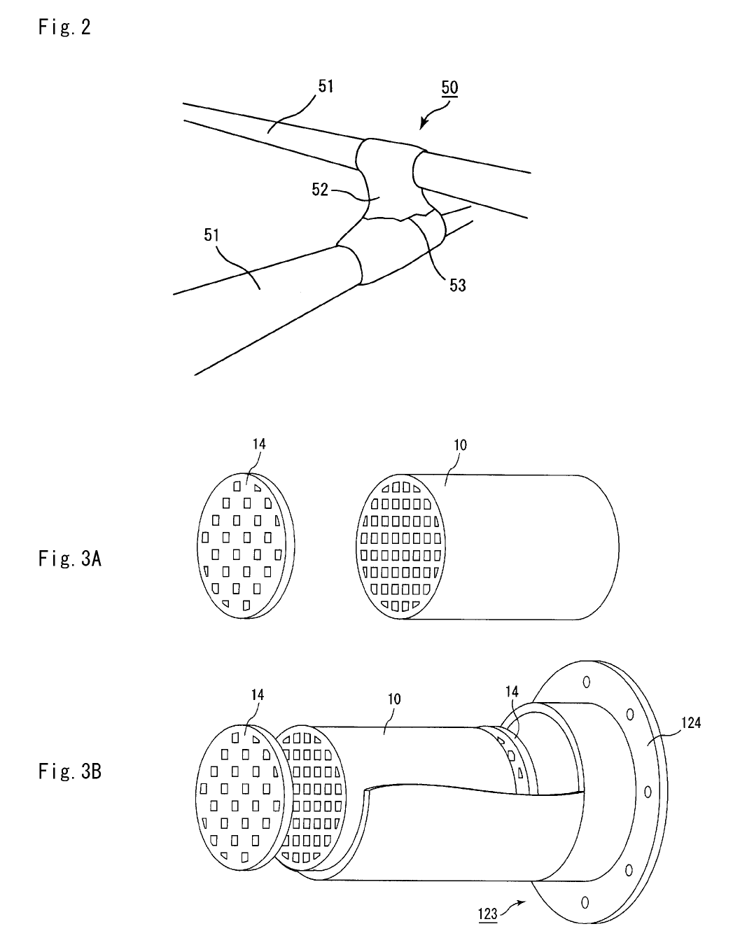

FIG. 2 is a portion of a honeycomb structure 10 and a perspective view that schematically illustrates one example of an embodiment of a fixed portion in which an inorganic matter firmly fixes inorganic fibers to one another.

As illustrated in FIG. 2, a glass (silica) 52, an inorganic matter, is firmly fixed at the intersection between the alumina fibers 51, inorganic fibers, or in the vicinity thereof, and thereby the glass 52, firmly fixed at the intersection or in the vicinity thereof, forms a fixed portion 50 and serves so as to simultaneously couple two of the alumina fibers 51 to one another at the intersection or in the vicinity thereof. Here, the glass 52 is firmly fixed at the intersection between the alumina fibers 51 or in the vicinity thereof, by undergoing melting and solidification.

As is illustrated in FIG. 2, in the case where the glass 52 is locally located at the intersection of the alumina fibers 51 or in the vicinity thereof, many of the alumina fibers 51 are coated with the glass 52 at the intersection of the alumina fibers 51 with other alumina fibers 51 or in the vicinity thereof, with the glass being hardly fixed to most of the other portions.

In the present specification, the mutual intersection between the inorganic fibers or the vicinity thereof refers to an area within a distance of about ten times the fiber diameter of the inorganic fibers from the point at which the inorganic fibers are in closest contact with one another.

Here, the fixed portion 50 has a fissure 53, and it may be easier to alleviate a thermal stress in this fissure portion when temperature becomes high during the regenerating treatment. In this manner, in order to attain the desired degree of alleviation of the thermal stress, fixed portions 50 present in the honeycomb structure 10 appropriately contain some fixed portions 50 with a fissure 53. The fixed portions 50 with a fissure 53 are not lopsidedly present in part of regions of the honeycomb structure 10 but uniformly present in the entire honeycomb structure 10. Moreover, as illustrated in FIG. 2, the fissure 53 may be introduced into the entirety (or the entire periphery) of the fixed portion 50, or may be introduced into part of a region of the fixed portion 50.

In the honeycomb structure 10, the number of portions where alumina fibers 51 as inorganic fibers are firmly fixed to one another by interposing a glass 52 as an inorganic matter is not one per one alumina fiber 51, but there are some alumina fibers that are firmly fixed to one another by interposing a glass at two or more portions. Consequently, in the honeycomb structure 10, many alumina fibers are entangled with one another in a complex manner, which tends to prevent untangled alumina fibers, and thus the honeycomb structure 10 has a predetermined strength and has a configuration that facilitates alleviation of the thermal stress in the fixed portion upon generation of the thermal stress.

Members for an end portion 14 disposed on both end faces of the honeycomb structure 10 are plate members made of metal in which through holes are formed in predetermined positions. The through holes of the members for an end portion 14 are formed in such a manner that the cells of the honeycomb structure 10 are open in a checkered pattern on both end faces of the honeycomb structure 10 when the members for an end portion 14 are disposed on both end portions of the honeycomb structure 10. Here, when the members for an end portion 14 are disposed on both end portions of the honeycomb structure 10, through holes are not formed in the portion of the one member for an end portion 14 corresponding to the portion in which through holes are formed in the other member for an end portion 14; on the other hand, through holes are formed in the portion of one member for an end portion 14 corresponding to the portion in which through holes are not formed in the other member for an end portion 14. That is, the formation positions of the respective through holes are different in the members for an end portion disposed on both end portions. In addition, either one of the end portions of each of the cells are sealed by disposing such members for an end portion 14.

Next, the following description will discuss the method for manufacturing the honeycomb structure according to the first embodiment of the present invention. Here, a manufacturing method thereof in the case of using the honeycomb structure as a filter will be described.

(1) Mixed are alumina fibers (as inorganic fibers) that are inorganic fibers mainly forming the honeycomb structure; glass fibers (as a raw material of an inorganic matter) that are to firmly fix alumina fibers to one another through the subsequent processes to form a fixed portion; organic binders; and water. Then, the resultant mixture is further mixed with a pore-forming agent, a plasticizer, a lubricant, and the like, if necessary, to prepare a mixture for molding.

(2) Subsequently, a pillar-shaped molded body with a large number of cells formed in the longitudinal direction is manufactured by carrying into a plunger-type molding machine the mixture for molding, and continuously extruding the mixture for molding through a die in which predetermined through holes are formed in the plunger-type molding machine.

(3) The following treatments are carried out: a cutting treatment for cutting the extruded molded body to a predetermined length to manufacture a honeycomb molded body, an integrally molded body; a drying treatment for removing moisture in the molded body; and a degreasing treatment for removing an organic matter during the molding.

Here, the drying treatment and the degreasing treatment may be performed if necessary.

Here, upon cutting the honeycomb molded body, in which to the end portion to which the molded body molded in the extrusion-molding process is transferred, a molded body cutting apparatus provided with a cutting means such as a laser and a cutter is used. In this molded body cutting apparatus, while the cutting means is being transferred at a speed synchronous to the extruding speed of the molding body, the molded body is cut by the cutting means. It is possible to carry out the cutting process continuously by using the cutting apparatus having the above-mentioned mechanism, and consequently to improve the mass productivity.

In addition, the drying treatment may be carried out by using, for example, a microwave heat drying apparatus, a hot-air drying apparatus, an infrared ray drying apparatus or the like, and in this case, a plurality of these apparatuses may be used in combination.

Specifically, in the case of using a hot-air drying apparatus, for example, the drying treatment may be carried out at a set temperature of at least about 100° C. and at most about 150° C. for at least about 5 minutes and at most about 60 minutes under ambient atmosphere. In this case, the arrangement is desirably made so that the hot air is directed to the molded body in parallel with the longitudinal direction thereof so as to allow the hot air to pass through the cells. By allowing the hot air to pass through the cells of the molded body, the drying treatment of the molded body will be carried out efficiently.

Normally, the degreasing treatment is desirably carried out in an oxidizing atmosphere such as ambient atmosphere so as to oxidatively decompose the organic substances. Specifically, the degreasing treatment may be carried out by heating at a set temperature of at least about 200° C. and at most about 600° C. under ambient atmosphere for at least about 1 hour and at most about 5 hours. With respect to the degreasing furnace used herein, not particularly limited, a batch-type degreasing furnace may be used; however, in order to continuously carry out the treatment, a continuous furnace provided with a belt conveyor is desirably used.

(4) A heating treatment is performed of heating the molded body at a temperature less than the melting point of the alumina fibers as inorganic fibers and not less than the melting point of the glass matter as an inorganic matter.

More specifically, the heating treatment may be carried out at a temperature of at least about 900° C. and at most about 1050° C. for at least about 5 hours and at most about 15 hours.

Through this heating treatment, the alumina fibers are firmly fixed to one another by interposing an inorganic matter including the glass fibers.

(5) The heated honeycomb molded body is cooled to a normal temperature (room temperature: at least about 15° C. and at most about 25° C.) to manufacture a honeycomb structure including a honeycomb member. The melted inorganic matter is solidified by cooling a honeycomb molded body to thereby form a fixed portion in which alumina fibers are firmly fixed to one another in the honeycomb member. The average rate of change of the temperature drop to a normal temperature upon this cooling is at least about 50° C./hr and at most about 500° C./hr. It may be easier to introduce a fissure into part of the fixed portion to be formed upon cooling the honeycomb molded body, by setting the value within the aforementioned range as the average rate of change of the temperature drop. The average rate of change of the temperature drop to a normal temperature (° C./hr) can be found by dividing the temperature difference (° C.) between the maximum value of the heating temperature achieved during the heating treatment and a normal temperature by a period of time (hr) needed to cool the honeycomb molded body by the temperature difference.

(6) An acid treatment may be carried out on the honeycomb structure, if necessary, after manufacturing the honeycomb structure by this method.

The acid treatment may be conducted by immersing the honeycomb structure in a solution such as a hydrochloric acid solution and a sulfuric acid solution. More specifically, the acid treatment may be performed, for example, in the solution having a concentration of at least about 1 mol/l and at most about 10 mol/l, at a treatment period of time of at least about 0.5 hours and at most about 24 hours, and for a treatment temperature of at least about 70° C. and at most about 100° C.

By carrying out the acid treatment, components other than silica are eluted, so that the heat resistance of the honeycomb structure is consequently improved.

Moreover, the heating treatment may be performed again after the acid treatment.

More specifically, the heating treatment may be carried out at about 1050° C. for about 5 hours.

(7) Members for an end portion are manufactured separately from the processes (1) to (6) upon using a honeycomb structure as a filter.

More specifically, after a metal plate is machined into a disk shape having a predetermined shape, through holes are formed in a predetermined position through a laser machining process or a punching process; thereby the members for an end portion are manufactured.

(8) Next, the members for an end portion are disposed on both end faces of the honeycomb structure. The members for an end portion are disposed on both end faces of the honeycomb structure inside a metal casing while positioning both the members for an end portion and the honeycomb structure. This method will be described in reference to the drawings.

FIG. 3A is a perspective view that schematically illustrates a honeycomb structure according to one embodiment of the present invention and a member for an end portion that configure a honeycomb structure, and FIG. 3B is a perspective view for describing a method for disposing the member for an end portion on both end portions of the honeycomb structure illustrated in FIG. 3A.

A honeycomb structure 10 and (two) members for an end portion 14, as illustrated in FIG. 3A, are manufactured, and simultaneously, a metal casing 123 having a can-type (cylindrical) shape with a pressing metal member 124 attached on one side, as illustrated in FIG. 3B, is prepared separately. And one member for an end portion 14 is disposed on a side of a pressing metal member 124 in the casing 123. Next, the honeycomb structure 10 is disposed while being positioned with the pre-placed member for an end portion 14, and thereafter the other member for an end portion 14 is disposed while being positioned with the honeycomb structure 10. Subsequently, another pressing metal member is attached and fixed to the other side opposite to the side where the above-mentioned pressing metal member 124 is attached.

Hereinafter, the effects of the honeycomb structure according to the present embodiment will be mentioned.

(1) Since part of a fixed portion formed by an inorganic matter has a fissure, when a thermal stress arises in the honeycomb structure in use it may be easier to alleviate the thermal stress in the fixed portion with a fissure. The fixed portion uniformly present in the entire honeycomb structure tends to cause the alleviation of the thermal stress in the respective portions, and it may be easier to obtain a honeycomb structure having high thermal shock resistance and achieving a good balance between rigidity and toughness on the whole.

(2) Since the inorganic matter contains silica, it may be easier to obtain a honeycomb structure excellent in heat resistance.

(3) Since the inorganic fibers are alumina fibers, it may be easier to improve the heat resistance of the honeycomb structure.

(4) Since the honeycomb structure includes one member, it may be easier to improve the production efficiency of the honeycomb structure.

(5) The honeycomb molded body is heated at a temperature less than the melting point of the inorganic fibers and not less than the melting point of the raw material of the inorganic matter; and the heated honeycomb molded body is cooled to manufacture a honeycomb structure including a honeycomb member, wherein a fissure is introduced into a fixed portion in the honeycomb member by setting to at least about 50° C./hr and at most about 500° C./hr an average rate of change of the temperature drop to a normal temperature, the fixed portion being formed by firmly fixing the inorganic fibers to one another by interposing the inorganic matter in the honeycomb member. Thus, it may be easier to introduce a fissure into the fixed portion by generating an appropriate thermal stress in the process of forming the fixed portion.

The following description will discuss the first embodiment in further detail by Examples, and the present invention is not limited only to these Examples.

### EXAMPLE 1

(A. Manufacture of Honeycomb Structure)

(1) First, 12.3 parts by weight of silica-alumina fibers (average fiber length: 0.3 mm, average fiber diameter: 5 μm) made of 72% of alumina and 28% of silica, 6.2 parts by weight of glass fibers (average fiber diameter: 5 μm, average fiber length: 0.1 mm), 11.7 parts by weight of an organic binder (methyl cellulose), 7.1 parts by weight of a pore-forming agent (acryl resin), 8.1 parts by weight of a plasticizer (UNILUB, made by NOF Corporation), 3.8 parts by weight of a lubricant (glycerin), and 50.9 parts by weight of water were mixed, and sufficiently stirred to prepare a mixture for molding.

(2) The mixture for molding was carried in a cylinder from a mixture tank of a plunger-type extrusion-molding machine, and the piston was pressed toward the die side so that the mixture was extruded through the die to manufacture a round pillar-shaped molded body.

(3) The molded body having a round pillar shape was cut by using a cutting apparatus having a cutting disc as its cutting member, to obtain a honeycomb molded body.

(4) The honeycomb molded body, obtained in the process (3), was dried at 200° C. for 3 hours under ambient atmosphere by using a microwave drying apparatus and a hot-air drying apparatus so that moisture contained in the honeycomb molded body was removed.

(5) The honeycomb molded body, obtained through the drying treatment, underwent a degreasing treatment for removing organic substances contained in the honeycomb molded body by heating on the molded body at 400° C. for 3 hours in an electric furnace under ambient atmosphere.

(6) The honeycomb molded body, obtained through the degreasing treatment, underwent a heating treatment at 950° C. for 5 hours in a firing furnace under ambient atmosphere. Thereafter, the resulting molded body was immersed into an HCl solution of 4 mol/l at 90° C. for one hour so that an acid treatment was carried out thereon, and this again underwent a heating treatment at 1050° C. for 5 hours in a firing furnace under ambient atmosphere.

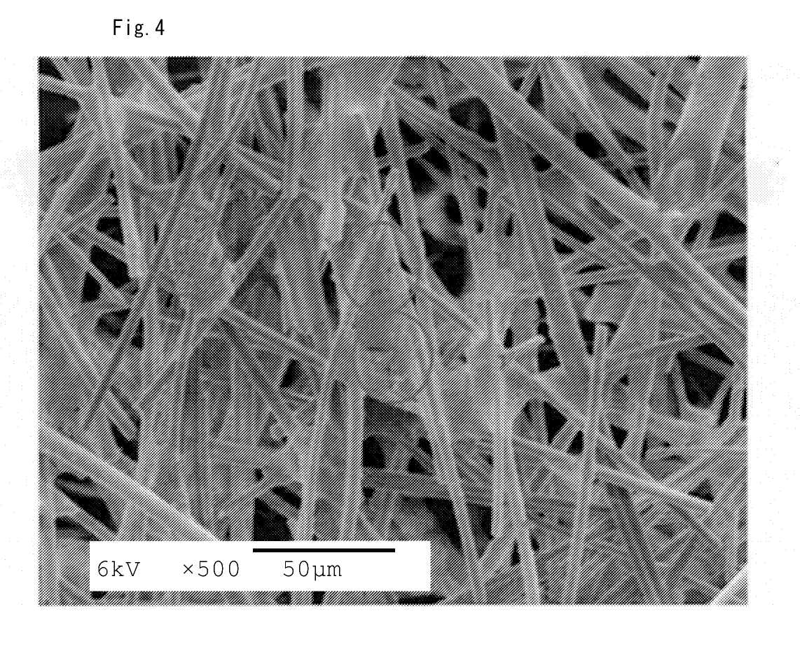

(7) After completion of the heating treatment at 1050° C. for five hours, the heated honeycomb molded body was cooled by setting the average rate of change of the temperature drop to 150° C./hr to manufacture a honeycomb structure having cells of 4.5 mm×4.5 mm with mutual intervals of 2 mm and having a length of 60 mm in the longitudinal direction. Through the process (7), a fissure is formed in a fixed portion in which alumina fibers are firmly fixed to one another by interposing a glass. FIG. 4 is an electron microscope photograph of a fixed portion with a fissure formed therein.

### (B. Manufacture of Member for End Portion)

After a metal plate made of Ni—Cr alloy had been machined into a disc shape having a diameter of 160 mm×a thickness of 1 mm, a laser machining process is carried out on this so that a member for an end portion with through holes of 4.5 mm×4.5 mm formed in a predetermined position was manufactured.

Two members for an end portion were manufactured in this process, and through holes were formed in each of these members for an end portion at mutually different positions so that portions of the sealed cells were made different between one end face and the other end face of the honeycomb structure when the members for an end portion were disposed in the subsequent process.

### (C. Disposition of Member for End Portion in Honeycomb Structure)

First, a casing (see FIG. 3B) having a can-type (cylindrical) shape made of SUS with a pressing metal member attached on one side was prepared and vertically placed with the side on which the pressing metal member had been attached facing down. Thereafter, one of the members for an end portion, obtained in the process B, a honeycomb structure, obtained in the process A, and the other member for an end portion were placed in this order in the metal casing while each of their through holes being positioned. Subsequently, the pressing metal member was attached and fixed to the other end of the casing. In this process, the members for an end portion were disposed in such a manner that portions of the sealed cells were made different between the end face on the inlet side and the end face on the outlet side of the honeycomb structure (i.e. so that only either one of the end portions of each of the cells was sealed). This leads to the honeycomb structure functioning as a filter.

### (Evaluation on Presence of Fissure in Fixed Portion)

The presence of a fissure was evaluated in the fixed portion of the manufactured honeycomb structure based on an electron microscope photograph. Here, the fissure refers to a fine fissure pre-formed in the fixed portion, and the fissure having a size of several micrometers to hundreds of micrometers was evaluated to be a fissure.

Table 1 shows the results.

TABLE 1

| | Average rate | Before regenerating treatment | | After regenerating |
|---|---|---|---|---|
| | of change of | Presence of | Presence of crack | treatment |
| | temperature | fissure in | in honeycomb | Presence of crack in |
| | drop [° C.] | fixed portion | structure | honeycomb structure |
| Example 1 | 150 | present | absent | absent |
| Example 2 | 50 | present | absent | absent |
| Example 3 | 500 | present | absent | absent |
| Comparative | 30 | absent | absent | present |
| Example 1 | | | | |
| Comparative | 600 | NA | present | NA |
| Example 2 | | | | |

NA = Not Available

### (Evaluation on Presence of Cracks Upon Regenerating Treatment)

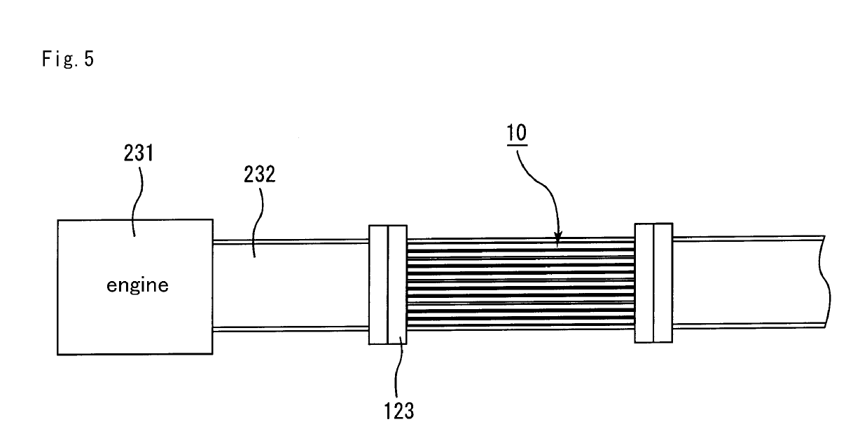

As illustrated in FIG. 5, a honeycomb structure 10 and members for an end portion 14 were installed in the metal casing 123 so that the honeycomb structure 10 may function as a filter, and then a 2L diesel engine 231 connected to an introducing pipe 232 was driven at the number of revolutions of 3000 min-1 and a torque of 40 Nm until the amount of captured PMs had reached 6 g/L. Thereafter, the engine 231 was driven at full load at the number of revolutions of 4000 min-1, and at the time when the temperature of the honeycomb structure 10 became constant at about 700° C., the engine was driven at the number of revolutions of 1050 min-1 and a torque of 30 Nm so that PMs were forcefully burned. Visual observation was made on the presence of cracks in the honeycomb structure 10 at this time before and after the regenerating treatment. Here, the cracks refer to visible cracks generated by a thermal shock, and the cracks having a size of approximately several millimeters to tens of millimeters were evaluated to be cracks.

Table 1 shows the results.

### EXAMPLES 2 AND 3

A honeycomb structure was manufactured in the same manner as in Example 1, except that in the process A(7) of Example 1, the average rate of change of the temperature drop was changed to the values shown in Table 1.

And the same evaluations as in Example 1 were made regarding the honeycomb structured bodies of Examples 2 and 3.

Table 1 shows the results.

### COMPARATIVE EXAMPLES 1 AND 2

A honeycomb structure was manufactured in the same manner as in Example 1, except that in the process A(7) of Example 1, the average rate of change of the temperature drop was changed to the values shown in Table 1.

And the same evaluations as in Example 1 were made regarding the honeycomb structured bodies of Comparative Examples 1 and 2.

Table 1 shows the results.

As shown in Table 1, in each of the honeycomb structured bodies according to Examples 1 to 3, a fissure was introduced into the fixed portion, and no cracks were generated upon the regenerating treatment, and the regenerating treatment was favorably performed. This is presumably because the fissure in the fixed portion alleviated a thermal shock during the regenerating treatment.

On the other hand, in the honeycomb structure according to Comparative Example 1, cracks occurred after the regenerating treatment, and durability thereof was low upon the regenerating treatment. This is probably because in Comparative Example 1 a fissure was not introduced into a fixed portion due to a small average rate of change of the temperature drop and thereby alleviation of a thermal stress was not achieved. Moreover, in Comparative Example 2, cracks had generated before the regenerating treatment of the honeycomb structure was performed. This is supposedly because the average rate of change of the temperature drop was so large that cracks generated at that point in time.

### Other Embodiments

In the honeycomb structure according to the embodiments of the present invention, a catalyst may be supported on at least part of the inorganic fibers. As long as able to lower the burning temperature of PMs, the catalyst is not particularly limited, and desirably an oxide catalyst. Examples of the oxide catalyst include CeO_{2, K}₂O, ZrO₂, FeO₂, Fe₂O₃, CuO, CuO₂, Mn₂O₃, MnO, and complex oxides indicated by a composition formula AₙB₁₋ₙCO₃, provided that in the formula, A is La, Nd, Sm, Eu, Gd or Y, B is an alkali metal or alkali-earth metal, and C is Mn, Co, Fe, or Ni. These may be used independently, or two or more of them may be used in combination, and the oxide catalyst desirably contains at least CeO₂. The burning temperature of PMs tends to be lowered by supporting such an oxide catalyst.

The amount of the supported catalyst (g/L) is desirably set to at least about 10 g/L and at most about 200 g/L with respect to the apparent volume (L) of the honeycomb structure.

The amount of the supported catalyst of about 10 g/L or more tends to cause less portions of the honeycomb structure in which no catalyst is supported, tending not to cause a reduction in the possibility of PMs coming into contact with the catalyst and tending to sufficiently lower the burning temperature of PMs. In contrast, even when the amount thereof is more than about 200 g/L, the possibility of contact between PMs and the catalyst is not improved so much; therefore, the amount of about 200 g/l or less is desirable.

With respect to the fiber length of the inorganic fibers forming the honeycomb structure, the desirable lower limit value is about 0.1 mm, and the desirable upper limit value is about 100 mm.

The fiber length of about 0.1 mm or more makes it easier to entangle the inorganic fibers with one another and firmly fix the inorganic fibers to one another by interposing an inorganic matter, and tends not to provide insufficient strength of the honeycomb structure; in contrast, the fiber length of about 100 mm or less makes it easier to manufacture a homogeneous honeycomb structure, and it may be easier to provide a honeycomb structure having sufficient strength.

The more desirable lower limit value of the fiber length is about 0.5 mm, and the more desirable upper limit value is about 50 mm.

With respect to the fiber diameter of the inorganic fibers, the desirable lower limit value is about 0.3 μm, and the desirable upper limit value is about 30 μm.

The fiber diameter of about 0.3 μm or more tends not to cause the inorganic fiber to be easily broken, with the result that the obtained honeycomb structure becomes less susceptible to wind erosion; in contrast, the fiber diameter of about 30 μm or less tends not to make it difficult for an inorganic matter such as a glass to firmly fix inorganic fibers to one another, making it easier to provide sufficient strength.

The lower limit value of the fiber diameter is more desirably about 0.5 μm, and the upper limit value thereof is more desirably about 15 μm.

The average pore diameter of the honeycomb structure is desirably at least about 1 μm and at most about 100 μm.

In the case where the average pore diameter is about 1 μm or more, deep-layer filtering of PMs is more likely to be performed, with the result that a pressure loss tends not to increase in a short period of time. On the other hand, when the average pore diameter is about 100 μm or less, PMs tend not to pass through the pores, making it easier to function as a filter.

Here, the porosity and pore diameter can be measured through conventionally known methods, such as a measuring method using a mercury porosimeter, Archimedes method, and a measuring method using a scanning electron microscope (SEM).

Moreover, in the honeycomb structure, a thickness of the cell wall is desirably about 0.2 mm or more. The thickness of about 0.2 mm or more tends not to cause insufficient strength of the honeycomb structure.

Here, the desirable upper limit of the thickness of the cell wall is less than about 5.0 mm. In the case where the thickness of the cell wall is less than about 5.0 mm, the pressure loss tends not to be high. Moreover, ashes generated upon burning of PMs tend not to enter the pores deeply, making it easier to draw the ashes.

And the desirable aperture (opening) ratio of the honeycomb structure is at least about 30% and at most about 60%.

In the case where the aperture ratio is about 30% or more, the pressure loss of the honeycomb structure tends not to be too high; and the aperture ratio of about 60% or less tends not to cause insufficient strength of the honeycomb structure.

The cell density on the plane perpendicular to the longitudinal direction of the cells of the honeycomb structure (hereinafter, simply referred to as the cross section of the honeycomb structure) is not particularly limited, and the lower limit thereof is desirably about 0.16 pcs/cm² (about 1.0 pc/in²), and the upper limit thereof is desirably about 93 pcs/cm² (about 600 pcs/in²); more desirably, the lower limit value is about 0.62 pcs/cm² (about 4.0 pcs/in²), and the upper limit value is about 77.5 pcs/cm² (about 500 pcs/in²).

The cell size on the cross section of the honeycomb structure is not particularly limited, and the lower limit thereof is desirably about 0.8 mm×about 0.8 mm, and the upper limit thereof is desirably about 16 mm×about 16 mm.

The apparent density of the honeycomb structure is desirably at least about 0.04 g/cm³ and at most about 0.4 g/cm³.

The apparent density of about 0.04 g/cm³ or more tends not to cause insufficient strength; whereas in the case where the apparent density exceeds about 0.4 g/cm3 or less, the temperature of the honeycomb structure tends to increase during the regenerating treatment and is advantageous in continuously burning PMs.

Here, the apparent density of the honeycomb structure refers to a value obtained by dividing the mass (g) of the honeycomb structure by the apparent volume (cm3) of the honeycomb structure. And the apparent volume of the honeycomb structure refers to a volume obtained by calculating the outer shape of the honeycomb structure, a volume including pores and apertures (cells) of the honeycomb structure.

The tensile strength of the honeycomb structure configuring the honeycomb structure is desirably about 0.3 MPa or more, and more desirably about 0.4 MPa or more. The tensile strength of less than about 0.3 MPa tends not to provide insufficient reliability to the honeycomb structure.

Here, the tensile strength can be measured by forming the honeycomb structure into a sheet shape, with the two end faces thereof being fixed by jigs, and by measuring this with the use of an INSTRON type universal tensile meter.

The shape of the cells on the cross section of the honeycomb structure is not particularly limited to a square shape, and any desired shape, such as a triangular shape, a hexagonal shape, an octagonal shape, a dodecagonal shape, a round shape, an elliptical shape and a star shape, may be used.

The shape of the cross section of the honeycomb structure according to the embodiments of the present invention is not particularly limited to a round shape, and various shapes such as a rectangular shape may be used; however, it is desirable to use a shape enclosed only by a curved line or by curved lines and straight lines. In addition to a round shape, specific examples thereof include a rectangular pillar shape, an elongated round shape (racetrack shape), a shape in which one portion of a simple closed curved line such as a rectangular pillar shape or a racetrack shape has a recess portion (concave shape), and the like.

The member for an end portion configuring the honeycomb structure is not particularly limited as long as through holes are formed in a predetermined position, and the material thereof may be the same material as that of the honeycomb structure or may be a porous or solid (dense) metal ceramic.

Here, in the case where a metal member for an end portion is used as the member for an end portion, it is possible to simultaneously give a role as a pressing metal member to the member for an end portion by welding the member for an end portion upon disposing the member for an end portion in a metal casing.

Examples of the material for the casing include metals etc. such as stainless steel (SUS), aluminum, and iron.

A plunger-type molding machine to be used upon extrusion molding a mixture for molding in the process for manufacturing the honeycomb structure will be described in further detail in reference to the drawing.

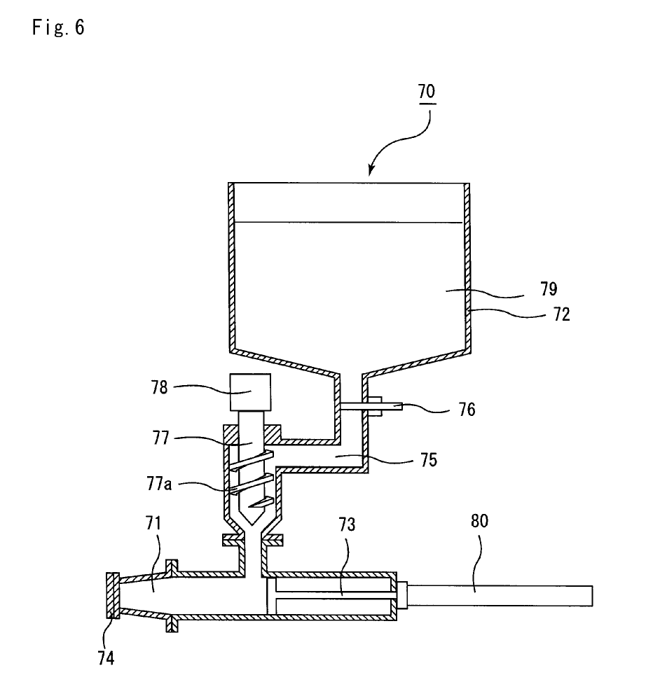

FIG. 6 is a cross-sectional view that schematically illustrates a plunger-type molding machine.

A plunger-type molding machine 70 is formed by: a cylinder 71; a piston 73 provided with a mechanism capable of reciprocally moving between the front side and the rear side in the cylinder (transverse direction in the figure); a die 74 that is attached to the tip of the cylinder, and has pores formed therein so as to carry out an extrusion-molding process to form a pillar-shaped molded body with a large number of cells formed in the longitudinal direction; and a mixture tank 72, placed on the upper portion of the cylinder 71, to which a pipe 75 is connected from the cylinder 71. Moreover, a shutter 76 is placed just below the mixture tank 72 so that the carry-in operation of the mixture from the mixture tank 72 tends to be interrupted. Here, a screw 77 with blades 77a is attached to the pipe 75 and allowed to rotate by a motor 78. The size of the blade 77a is virtually the same as the diameter of the pipe so that the mixture 79 is hardly allowed to flow reversely. Here, the mixture prepared in the mixing process is carried in the mixture tank 72.

Upon manufacturing a molded body by using the plunger-type molding machine 70, first, the shutter 76 is opened, and the mixture, obtained in the mixing process, is carried in the cylinder 71 from the mixture tank 72 by rotating the screw. At this time, the piston 73 is moved to the end portion of the cylinder 71 on the right side in FIG. 6 according to the carry-in amount of the mixture.

When the cylinder 71 is filled with the mixture, the shutter 76 is closed and the rotation of the screw 77 is simultaneously stopped. When the piston 73 is pressed and shoved into the die side with the inside of the cylinder 71 being filled with the mixture 79, the mixture is extruded through the die 74 so that a pillar-shaped molded body in which a plurality of cells are formed with a wall portion therebetween is continuously formed. At this time, according to the shape of the pore formed in the die, cells having the corresponding shape are formed. By repeating these processes, a molded body can be manufactured. Depending on the viscosity and the like, a molded body can be continuously manufactured, by rotating the screw 77 with the cylinder 73 being stopped.

Here, in the plunger-type molding machine 70 illustrated in FIG. 6, an oil cylinder 80 is used as the driving source used for shifting the piston 73; however, an air cylinder may be used, or a ball screw or the like may also be used.

Examples of the molding machine to be used upon extrusion molding a mixture for molding include a single-axis screw-type extrusion-molding machine, a multi-axis screw-type extrusion-molding machine, and the like, in addition to a plunger-type molding machine.

In the method for manufacturing the honeycomb structure according to the first embodiment of the present invention, a honeycomb structure is manufactured by molding a mixture for molding with a plunger-type molding machine, and thereafter carrying out a drying treatment, a degreasing treatment, a heating treatment, and a predetermined cooling treatment thereon; however, the honeycomb structure may be manufactured by other methods.

Examples of other methods for manufacturing a honeycomb structure according to the embodiments of the present invention include a method with use of a frame member (hereinafter, also referred to as a manufacturing method with use of a frame member) made of: a bottom plate on which pillar members used for forming cells of the honeycomb structure are installed vertically to the main surface and in a lattice pattern in a plan view; and an outer frame member provided so as to enclose the periphery of the bottom plate and the pillar members. Hereinafter, this method will be described in further detail.

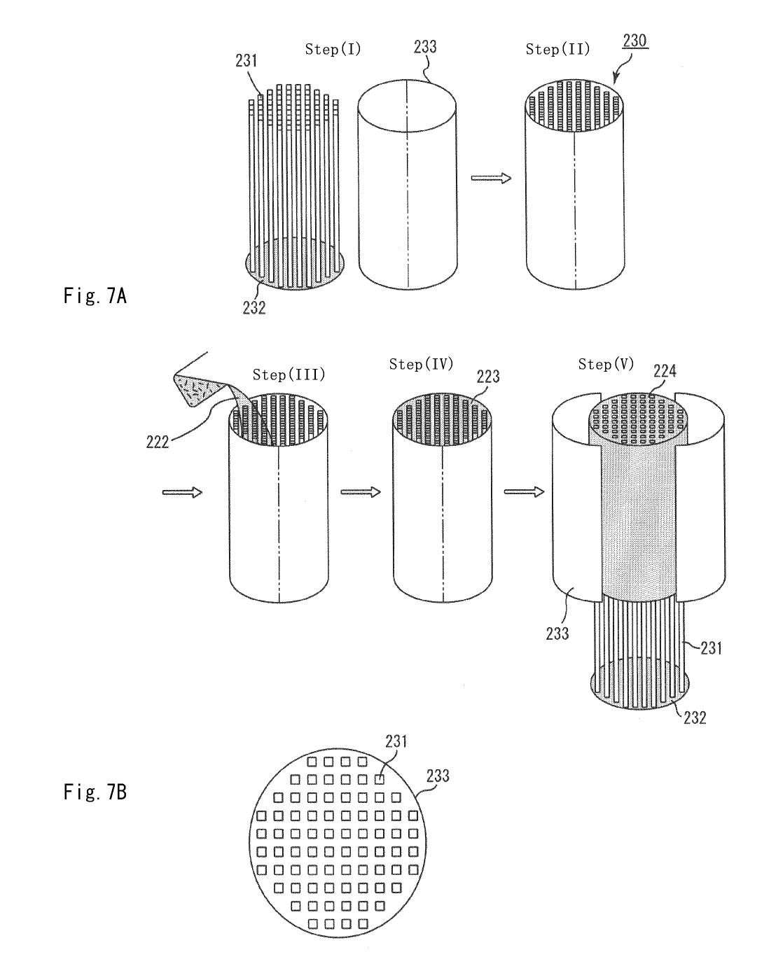

FIG. 7A is a schematic view for describing part of processes for a method for manufacturing a honeycomb structure according to the embodiments of the present invention used for a frame member, and FIG. 7B is a top view that schematically illustrates the inside of the frame member in which pillar members are vertically installed.

In the method for manufacturing the frame member, (1) First, a mixture for molding containing a thermosetting resin is prepared by mixing inorganic fibers mainly forming a honeycomb structure, an inorganic matter that is to firmly fix inorganic fibers to one another through the subsequent processes and thereby to form a fixed portion, and a thermosetting resin, and furthermore mixing a solvent, a dispersant, a curing agent, and the like if necessary.

(2) Next, the frame member is filled with the mixture for molding containing a thermosetting resin.

As the frame member, there is employed a frame member 230 (see FIG. 7A, step (II)) made of: a bottom plate 232 on which pillar members 231 used for forming cells of the honeycomb structure are installed vertically to the main surface and in a lattice pattern in a plan view (see FIG. 7A and FIG. 7B); and an outer frame member 233 (see FIG. 7A, step(I)) provided so as to enclose the periphery of the bottom plate 232 and the pillar members 231.

And the frame member 230 is filled with a mixture for molding containing a thermosetting resin 222 (see FIG. 7A, step(III)).

Here, a metal frame member can be preferably used as a frame member.

(3) Next, a thermosetting resin in the mixture for molding containing a thermosetting resin filled into the frame member 230 is cured, and a cured resin body 223 is formed inside the frame member 230 (see FIG. 7A, step(IV)).

(4) Next, the frame members 230 are removed from a cured resin body 223.

By detaching the pillar members 231, cells are formed in portions that have been occupied by the pillar members 231, and these are allowed to form cells for the honeycomb structure through the following processes (see FIG. 7A, step(V)).

In this case, it is desirable to preliminarily form a draft angle of about 2° in each pillar member 231 so that the pillar members 231 can be easily drawn from the cured resin body 223.

Moreover, the outer frame member 233 is separately detached so that a pillar-shaped molded body 224 is formed.

A honeycomb structure mainly including inorganic fibers and an inorganic matter can be manufactured by forming the molded body 224 as thus described, and thereafter carrying out a degreasing treatment, a heating treatment, and a predetermined cooling treatment thereon in the same manner as in the method for manufacturing the honeycomb structure of the first embodiment.

In addition, in the manufacturing method with use of a frame member, the method may be used in which: a cured resin body 223 is formed by using core sand used for casting of a mold, and the cores made of a resin material, low-melting-point metal, water-soluble salts on which a high-pressure press-molding process is carried out, and the like, instead of the pillar members 231; and thereafter the cores are removed by methods, such as a washing/elution method, a burning method, a thermal-fusing method, instead of drawing the pillar members 231.

Examples of other methods for manufacturing the honeycomb structure according to the embodiments of the present invention include a method with use of a vessel (hereinafter, also referred to as a manufacturing method through the three-dimensional sheet-forming process) that is made of: a vessel main body; a mesh formed on the bottom portion of the vessel main body; pillar-shaped masks that are installed vertically to the mesh and in a lattice pattern in a plan view, and are used for forming cells of the honeycomb structure; and a liquid-filling unit that forms a space surrounded by the pillar-shaped masks, with the mesh serving as the bottom face, in which the mixture is carried. Hereinafter, this method will be described in further detail.

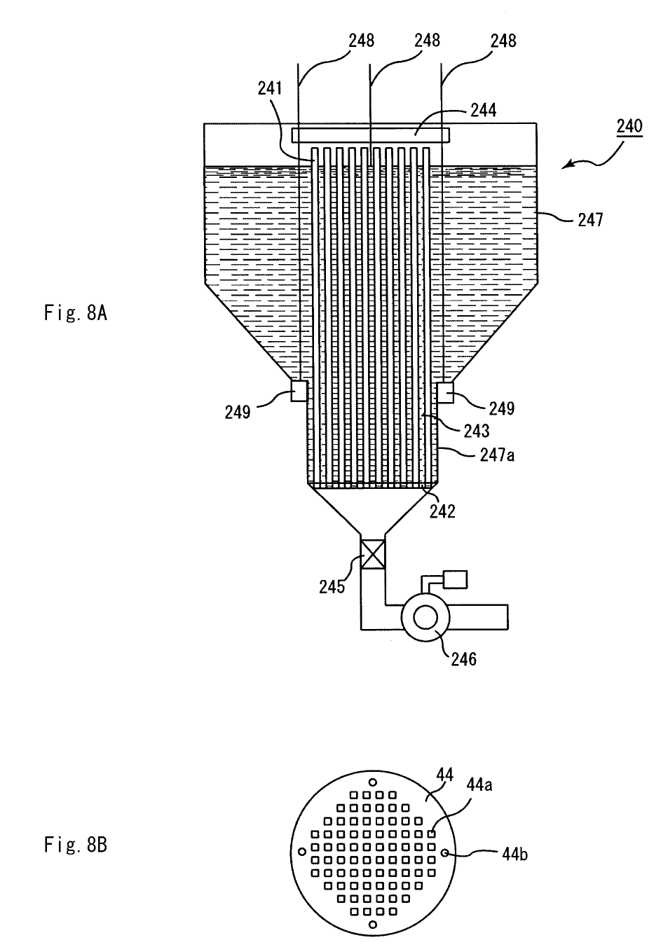

FIG. 8A is a view that schematically illustrates a vessel used in a manufacturing method through the three-dimensional sheet-forming process, and FIG. 8B is a top view that schematically illustrates a vessel used in the manufacturing method through the three-dimensional sheet-forming process.

In the manufacturing method with use of a vessel, (1) a mixture for molding is first prepared. The mixture for molding can be prepared by the same method as the method for manufacturing the honeycomb structure of the first embodiment. In this method, a mixture for molding with an increased blending amount of water and having a viscosity reduced so as to enable sheet-forming is prepared.

(2) Next, the mixture for molding is carried in a liquid-filling unit 243 of the vessel 240 illustrated in FIG. 8A.

The vessel 240 illustrated in FIG. 8A is configured by a vessel main body 247; a mesh 242 formed on the bottom portion of the vessel main body 247; pillar-shaped masks 241 that are installed vertically to the mesh 242 and in a lattice pattern in a plan view, and are used for forming cells of the honeycomb structure; and a liquid-filling unit 243 that forms a space surrounded by the pillar-shaped masks 241, with the mesh 242 serving as the bottom face, in which the mixture is carried.

Moreover, the vessel 240 is provided with: a pressing plate 244 with through holes 244a having a lattice pattern being formed in portions corresponding to the pillar-shaped masks 241; a cock 245 and a pump 246 used for draining; a press driving unit used for press-inserting the pressing plate 244 onto the vessel main body 247; and a vibration unit, not illustrated, used for giving vibration to the vessel main body.

Here, the preparation of the mixture for molding in the process (1) may be performed in the vessel 240.

After carrying into the liquid-filling unit the mixture for molding, the mixture filled into the liquid-filling unit 243 is stirred as needed. The stirring process may be carried out by activating a vibration unit, not illustrated, used for giving vibration to the vessel main body. With respect to the specific vibration unit, for example, an oscillator provided with an ultrasonic resonator, a vibrator and the like may be used, and the unit may be installed on the side face of the vessel main body 247. This may also be installed in the vessel main body 247.

(3) Next, a dehydration treatment is carried out in which moisture in the mixture for molding is sucked so that water in the mixture for molding is drained through the mesh 242.

In this case, the cock 245 placed on the lower side of the mesh 242 is opened, and the pump 246 is actuated. Thus, the mixture for molding, filled into the liquid-filling unit 243, is sucked and filtered, and allowed to drop through the mesh 242, and drained through the cock 245. Consequently, the water contained in the mixture for molding has been dehydrated, so that a dehydrated body having a predetermined height from the bottom portion of the liquid-filling unit is formed.

After the dehydration treatment, the dehydrated body that has been dehydrated in the dehydration process may undergo a pressing process for compressing it with the pressing plate from the upper face. By carrying out the compressing process by applying a pressure thereto, a compressed body having a predetermined length, appropriate density and porosity, can be formed.

The apparatus and the method used for the pressing treatment are not particularly limited to those described below. A vessel 240, illustrated in FIG. 8A, is provided with motors 249 and four ball screws 248 coupled to the motors 249, both serving as a press driving unit; the four ball screws 248 are threaded with four screw holes 244b formed in a pressing plate 244; thus, the four ball screws 248 rotate in synchronism with one another so that the pressing plate 244 can be raised and lowered.

Moreover, the pressing plate 244 is prepared as a plate, as illustrated in FIG. 8B, with through holes being formed in a lattice pattern in portions corresponding to the pillar masks 241.

Therefore, when the four motors 249 are driven in synchronism with one another, the pressing plate 244 is lowered downward so that the dehydrated body is compressed in the portion corresponding to the lower portion 247a of the vessel main body to be formed into a compressed body. As illustrated in FIG. 8A, the lower portion 247a of the vessel main body has a shape corresponding to a honeycomb structure so that when the pressing plate 244 is lowered to a portion at which the motors 249 are disposed, a compressed body having a round pillar shape is formed.

Here, the lower portion 247a of the vessel main body has a cylindrical shape, and the dehydrated body is compressed by the pressing plate 244, and filled into the lower portion 247a of the vessel main body to be formed in the shape of the honeycomb structure.

(4) Next, by removing the pillar-shaped masks from the dehydrated body, the mask-removing process is carried out to form a pillar-shaped molded body with a large number of cells formed in the longitudinal direction. Thus, a pillar-shaped molded body having cells with a predetermined shape and predetermined length and density can be obtained.

And a honeycomb structure mainly including inorganic fibers and an inorganic matter can be manufactured by forming the molded body as thus described, and thereafter carrying out a drying treatment, a degreasing treatment, a heating treatment, and a predetermined cooling treatment thereon in the same manner as in the method for manufacturing the honeycomb structure of the first embodiment.

The description has been presented hereinabove concerning methods for manufacturing a honeycomb structure including one member. However, a method for manufacturing a honeycomb structure according to the embodiments of the present invention is not limited to these methods, and the honeycomb structure may be manufactured by reducing the length of the one member to form a lamination member and then laminating the lamination member.

In this case as well, since lamination members having a fissure in the fixed portion are employed, it may be easier to suppress occurrence of cracks in the respective members, thereby improve the heat resistance of the honeycomb structure, and consequently to enhance reliability of the honeycomb structure as a product.

Obviously, numerous modifications and variations of the present invention are possible in light of the above teachings. It is therefore to be understood that within the scope of the appended claims, the invention may be practiced otherwise than as specifically described herein.

What is claimed as new and desired to be secured by Letters Patent of the United States is:

1. A honeycomb structure comprising:
a plurality of cells disposed substantially in parallel with one another in a longitudinal direction with a cell wall therebetween;
an inorganic fiber; and
an inorganic matter, said inorganic matter forming a fixed portion in which said inorganic fibers are fixed to one another, part of the fixed portion having a fissure.

2. The honeycomb structure according to claim 1, wherein said inorganic matter contains silica.

3. The honeycomb structure according to claim 1, wherein said inorganic fiber comprises at least one of a silicon carbide fiber, an alumina fiber, a basalt fiber, a silica fiber, a silica-alumina fiber, a titania fiber, and a zirconia fiber.

4. The honeycomb structure according to claim 1, wherein said honeycomb structure comprising one member.

5. The honeycomb structure according to claim 1, wherein said honeycomb structure comprising a plurality of lamination members laminated in said longitudinal direction.

6. The honeycomb structure according to claim 1, wherein said fixed portion has a fissure over an entire periphery of said fixed portion.

7. The honeycomb structure according to claim 1, wherein said cell wall has a porosity of at least about 75% and at most about 95%.

8. The honeycomb structure according to claim 1, wherein a plate member for an end portion with through holes formed in a predetermined position is disposed in such a manner that said cells of said honeycomb structure are open in a checkered pattern on both end faces of said honeycomb structure.

9. The honeycomb structure according to claim 1, wherein a catalyst is supported on at least part of said inorganic fibers.

10. The honeycomb structure according to claim 9,
wherein said catalyst comprises an oxide catalyst.

11. The honeycomb structure according to claim 10,
wherein said catalyst comprises CeO₂.

12. A method for manufacturing a honeycomb structure comprising a honeycomb member, comprising:
preparing a mixture containing an inorganic fiber and a raw material of an inorganic matter having a melting point lower than a melting point of said inorganic fiber;
molding said mixture to manufacture a honeycomb molded body in which a plurality of cells are disposed substantially in parallel with one another in a longitudinal direction with a cell wall therebetween;
heating said honeycomb molded body at a temperature lower than the melting point of said inorganic fiber and not lower than the melting point of said raw material of the inorganic matter; and
cooling the heated honeycomb molded body to manufacture the honeycomb member and to introduce a fissure into a fixed portion in said honeycomb member by setting an average changing rate of temperature dropping to a normal temperature at at least about 50° C./hr and at most about 500° C./hr, the fixed portion being formed by fixing said inorganic fibers to one another by interposing said inorganic matter in said honeycomb member.

13. The method for manufacturing a honeycomb structure according to claim 12,
wherein said inorganic matter contains silica.

14. The method for manufacturing a honeycomb structure according to claim 12,
wherein said inorganic fiber is at least one of a silicon carbide fiber, an alumina fiber, a basalt fiber, a silica fiber, a silica-alumina fiber, a titania fiber, and a zirconia fiber.

15. The method for manufacturing a honeycomb structure according to claim 12,
wherein said mixture is integrally molded through extrusion molding.

16. The method for manufacturing a honeycomb structure according to claim 15,
wherein said extrusion molding is a plunger-type molding.

17. The method for manufacturing a honeycomb structure according to claim 12, further comprising laminating said honeycomb member.

18. The method for manufacturing a honeycomb structure according to claim 15, wherein said extrusion molding is carried out by using at least one of a single-axis screw-type extrusion-molding machine and a multi-axis screw-type extrusion-molding machine.

19. The method for manufacturing a honeycomb structure according to claim 12, wherein said honeycomb molded body is heated at at least about 900° C. and at most about 1050° C.

20. The method for manufacturing a honeycomb structure according to claim 12, wherein an acid treatment is further carried out on said honeycomb structure.

21. The method for manufacturing a honeycomb structure according to claim 12, wherein said mixture is filled into a frame member and integrally molded in said frame member which comprises
a bottom plate on which pillar members configured to form cells of the honeycomb structure are installed vertically to a main surface of the bottom plate and installed in a lattice pattern in a plan view, and
an outer frame member provided so as to enclose a periphery of said bottom plate and said pillar members.

22. The method for manufacturing a honeycomb structure according to claim 21, wherein said mixture is integrally molded in said frame member by using cores instead of said pillar members, and said cores are removed by one of a washing and elution method, a burning method, and a thermal-fusing method.

23. The method for manufacturing a honeycomb structure according to claim 22, wherein said cores comprise one of core sand, a resin material, low-melting-point metal, and water-soluble salts on which a high-pressure press-molding process is carried out.

24. The method for manufacturing a honeycomb structure according to claim 12, wherein said mixture is filled into a vessel and integrally molded in said vessel which comprises
a vessel main body,
a mesh formed on a bottom portion of said vessel main body, pillar-shaped masks that are installed vertically to said mesh and are configured to form cells of the honeycomb structure, and
a liquid-filling unit that forms a space surrounded by said pillar-shaped masks with the mesh serving as the bottom face.

25. The method for manufacturing a honeycomb structure according to claim 12, further comprising supporting a catalyst on at least part of said inorganic fibers.

26. An exhaust gas purifying apparatus comprising:
a honeycomb structure;
a member for an end portion; and
a casing,
wherein
a first member for the end portion is disposed on a side of a first pressing metal member in the casing,
the honeycomb structure is disposed in said casing, through holes of the honeycomb structure being aligned with through holes of said first member for the end portion,
a second member for the end portion is disposed on a side opposite to a side of said first member for the end portion, through holes of the second member for the end portion being aligned with the through holes of said honeycomb structure, and
a second pressing metal is disposed on said second member for the end portion,
wherein
said honeycomb structure having a pillar shape in which a plurality of cells disposed substantially in parallel with one another in a longitudinal direction with a cell wall therebetween, comprises: an inorganic fiber; and an inorganic matter, said inorganic matter forming a fixed portion in which said inorganic fibers are fixed to one another, part of the fixed portion having a fissure.

27. The exhaust gas purifying apparatus according to claim 26, wherein said inorganic matter comprises silica.

28. The exhaust gas purifying apparatus according to claim 26, wherein said inorganic fiber is at least one of a silicon carbide fiber, an alumina fiber, a basalt fiber, a silica fiber, a silica-alumina fiber, a titania fiber, and a zirconia fiber.

29. The exhaust gas purifying apparatus according to claim 26, wherein said honeycomb structure comprising one member.

30. The exhaust gas purifying apparatus according to claim 26, wherein said honeycomb structure comprising a plurality of lamination members laminated in said longitudinal direction.

31. The exhaust gas purifying apparatus according to claim 26, wherein said fixed portion has a fissure over an entire periphery of said fixed portion.

32. The exhaust gas purifying apparatus according to claim 26, wherein said cell wall has a porosity of at least about 75% and at most about 95%.

33. The exhaust gas purifying apparatus according to claim 26, wherein a plate member for an end portion with through holes formed in a predetermined position is disposed in such a manner that said cells of said honeycomb structure are open in a checkered pattern on both end faces of said honeycomb structure.

34. The exhaust gas purifying apparatus according to claim 26, wherein a catalyst is supported on at least part of said inorganic fibers.

35. The exhaust gas purifying apparatus according to claim 34, wherein said catalyst comprises an oxide catalyst.

36. The exhaust gas purifying apparatus according to claim 35, wherein said catalyst comprises CeO₂.

37. The honeycomb structure according to claim 1, wherein the honeycomb structure has a pillar shape.

38. The method for manufacturing a honeycomb structure according to claim 12, wherein the honeycomb structure has a pillar shape.
